(19) United States
(12) Patent Application Publication
(10) Pub. No.: US 2015/0292471 A1
(43) Pub. Date: Oct. 15, 2015

(54) Hydraulic Pressure Generating System

(71) Applicant: ATMOCEAN, INC., Santa Fe, NM (US)

(72) Inventors: Philip W. Kithil, Sante Fe, NM (US); Philip S. Fullam, Rio Rancho, NM (US)

(21) Appl. No.: 14/443,158

(22) PCT Filed: Oct. 28, 2013
(86) PCT No.: PCT/US2013/067056

§ 371 Date: May 15, 2015

Related U.S. Application Data
(60) Provisional application No. 61/726,947, filed on Nov. 15, 2012.
(60) Provisional application No. 61/762,601, filed on Feb. 8, 2013.

(51) Int. Cl. F03B 13/14

(52) U.S. Cl. CPC F03B 13/14

(57) ABSTRACT

A water pressurization system, comprising a substantially vertical assembly, the assembly comprising non-rigid connectors during shipment and storage, with the connectors assuming a semi-rigid form when in operation.

### CROSS-REFERENCE TO RELATED APPLICATIONS

This application claims priority to and the benefit of the filing of U.S. Provisional Patent Application Ser. No. 61/726,947, entitled “Energy Storage System, Vessel for Hydraulic Pressure Conversion Apparatus, and Vessel Mooring Device”, filed on Nov. 15, 2012, and to U.S. Provisional Patent Application Ser. No. 61/762,601, entitled “Variable Water Anchor Using Flexible Panels”, filed on Feb. 8, 2013 ('601 Application), and the specifications and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The present invention relates to methods and apparatuses for generating power from ocean waves.

2. Description of Related Art

The present invention relates in part to Patent Cooperation Treaty Application No. PCT/US2012/043480 ('480 Application), which relates to a storage tank with closed bottom and open top which is positioned on the seafloor and is provided with a heavy moveable lid, which moves up or down in response to the injection or removal of pressurized seawater, controlled by pressure valves. The seawater injection is provided by one or more wave-operated seawater pumps which produce a flow of pressurized seawater inside a hose connected to the storage tank. Removal of the pressurized seawater occurs when the force of gravity acting on the heavy moveable top, produces pressure that is greater than the pressure inside the transmission line to shore. Under this condition, the pressurized seawater flows inside the hose from the tank to the shore, where it is converted to electricity.

### BRIEF SUMMARY OF THE INVENTION

The present invention is of a water pressurization system, comprising a substantially vertical assembly, the assembly comprising non-rigid connectors during shipment and storage, with the connectors assuming a semi-rigid form when in operation. In the preferred embodiment, the system further comprises a gimbal connection between a surface component and a water pressurizing device, and a hose connector which connects a substantially vertical hose to a substantially horizontal hose, the hose connector attached to a mooring by a mooring line, such that the distance between the hose connector and the mooring is variable. The variable distance between the hose connector and the mooring is governed by a surface or subsea float, the float attached to the mooring line. The vertical assembly comprises lay-flat hose.

The invention is also of a pressurized seawater storage tank provided with a gravity-induced mechanism external to the tank, to maintain a predetermined pressure in the tank. In the preferred embodiment, the tank resides on the seafloor, most preferably at a depth below the sea surface such that the top edge of the tank avoids interference with vessels on the sea surface. The tank is connected by ropes on pulleys to a moveable baffle within the tank, wherein the ropes pass through openings in the tank, most preferably wherein the openings are tightly sealed.

The invention is further of a moored vessel proximate to a seafloor electrical cable, the vessel provided with means to convert hydraulic pressure to electricity, the electricity conveyed to the seafloor cable by electrical transmission means. In the preferred embodiment, one end of the cable is offshore and the other end is onshore. The vessel is preferably a subsea vessel.

The invention is still further of a mooring comprising a heavy weight, the weight provided with angled appendages, and further provided with attachment means for a mooring cable.

The invention yet further is of a water anchor comprising flexible panels, the panels causing the water anchor to operate in a cyclical manner. In the preferred embodiment, the flexible panels comprise woven or non-woven fabric, the cycle changes according to wave motion, and the flexible panels assume a triangular shape, with one edge of the shape connected to a rigid circumferential structure, and the opposing apex of the shape secured by a rope to a second structure vertically offset from the origin of the rigid circumferential structure when the water anchor is operating. The water anchor is connected by a rope beneath a water pump. Multiple water anchors can be connected in series beneath a water pump. Multiple water pumps can be connected in series, wherein the water pumps are connected by water transmission lines and seafloor anchors are provided adjacent to one or both ends of the series of water pumps.

The present invention is additionally of a deployment method for an array of water pumps whereby the deployment vessel maintains headway during deployment of at least two individual pumps comprising the array.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 presents side views of the gimbal joint between piston rod and buoy in the invention;

FIG. 2 is a side view of the invention as deployed with hose extending upward from junction to pump;

FIG. 3 is a side view of the hose junction connecting to a seafloor hose extending to shore;

FIG. 4 is a side view of the invention as deployed with a mooring to a subsea float;

FIG. 5 is a side view of the pyramid shaped mooring in alternative placement configurations;

FIG. 6 is a top view of a layflat hose connection between pump and stack of variable sea anchors on a vessel;

FIG. 7 is a side view of connected pumps and buoys being towed to shore for servicing;

FIG. 8 is a perspective view of a seafloor tank of the invention;

FIG. 9 is a side view of a vessel with Pelton motor employed with the invention;

FIG. 10 is a perspective view of a weighted mooring with appendages;

FIG. 11A is a cross-sectional view of a variable water anchor of the invention when its buoy is rising on a wave;

FIG. 11B is a cross-sectional view of a variable water anchor of the invention when its buoy is descending on a wave; and

FIG. 12 is a plan view of a hexagonal variable water anchor of the invention (flexible panels in horizontal orientation, rope connections to second structural member not shown); and

FIG. 13 is a plan view of a flexible with braided ropes.

### DETAILED DESCRIPTION OF THE INVENTION

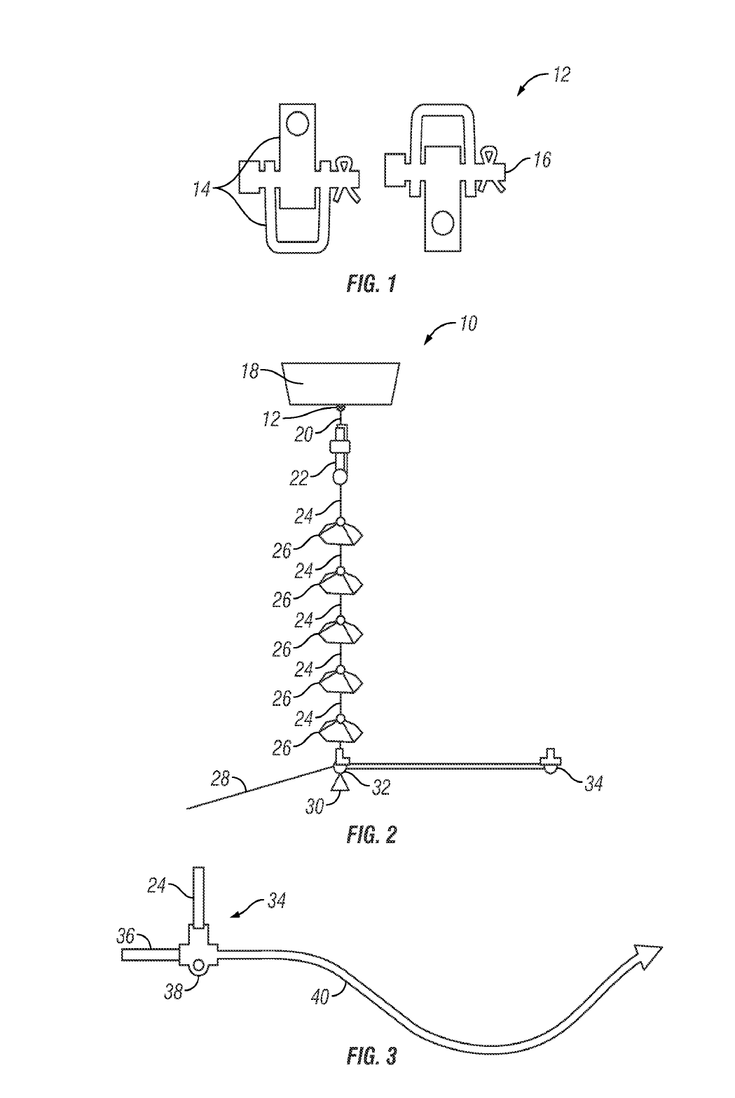

The present invention comprises a moveable connecting point between a seawater pump and a buoy, which allows the buoy to maintain normal orientation to passing waves, formed from a gimbal joint 12 between the piston rod 20 and the buoy 18 (see FIG. 1). The gimbal enables the piston rod to be connected directly to the gimbal joint and thence to the buoy, while still allowing the buoy to orient normal to the wave face. This arrangement avoids the use of a flexible cable or rope (11 in FIGS. 3 and 5 of the '480 Application) connecting the buoy to the piston rod. Testing has shown a cable or rope becomes slack as the buoy descends off the passing wave and then becomes taut on the next rising wave. This change from slack to taut imposes additional forces on the flexible cable or rope, which could cause premature failure. The gimbal joint avoids this problem.

The invention 10 comprises further improvements to the hydraulic pressure generating system (hereafter termed a “pump”) of the '480 Application, wherein a hose 24 extends vertically upward from a hose junction to the pump (FIG. 2). The hose junction is preferably a “T” or “L” connector 34,32, which connects adjacent hoses 36,40. Each vertical hose comprises one or more collars secured to the hose, said collars fitted with holes. Each hole may include a shackle to allow connection of a rope. The rope is attached from the hole or shackle in the collar, to a hole (or its shackle), provided in a typically hexagon-shaped perimeter structure which comprises the variable sea anchor as disclosed herein and in the '601 Application.

The vertical hose acts both as fluid transmission means from the pump, and as connector between adjacent variable sea anchors 26. As the pump 22 injects water into the hose, it becomes semi-rigid and thus provides a connecting means which is more secure than a rope or cable, the latter offering little rigidity. When the vertical hose is not pressurized, e.g., prior to deployment, it affords nearly as much flexibility as a rope, and thus is readily stacked either in storage, or on a vessel. This type of hose is typically called “layflat” 66 as it assumes a flat rather than round dimension prior to receiving water.

When the hose is pressurized and assumes a semi-rigid round form, in combination with the direct connection of the piston to the gimbal and thence to the buoy, the entire pump unit is thus semi-rigid from the sea surface to the hose junction. This attribute provides for higher efficiency as the wave energy is more directly concentrated on the piston and cylinder.

The hose junction connects the vertical hose to one or more horizontal hoses. The junction may be provided with one or more backflow preventers, comprising one-way valves, which maintain the flow of water in one direction, that direction being into a seafloor hose extending toward the energy conversion device preferably located onshore.

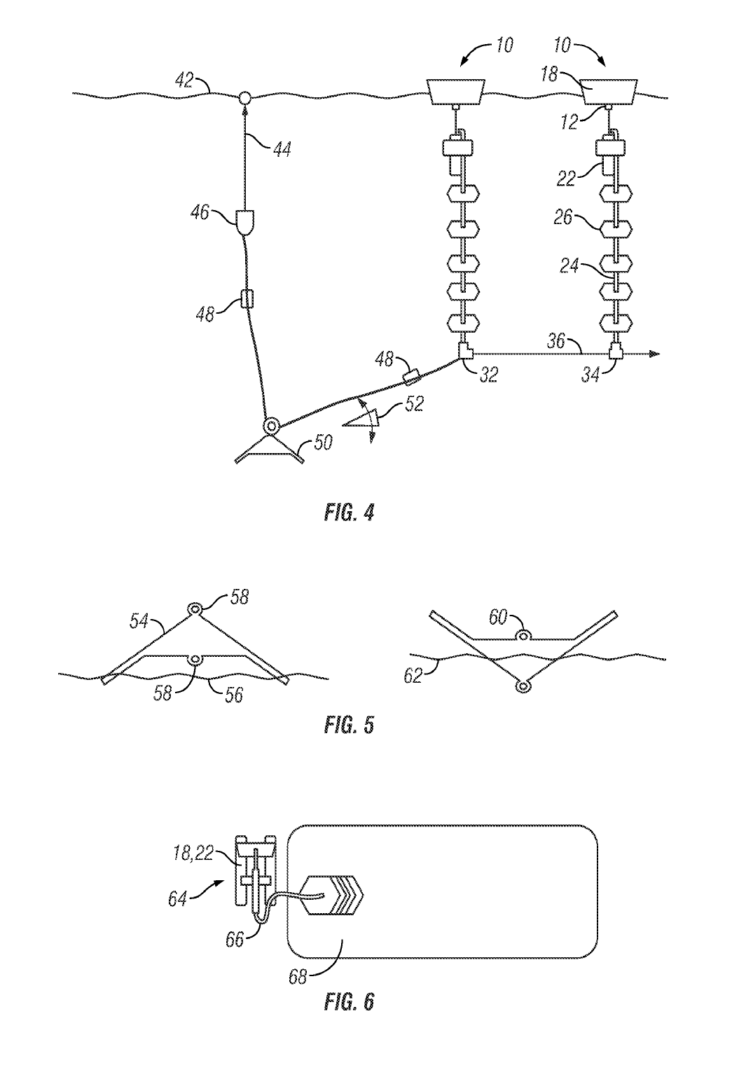

Multiple hose junctions thus serially connect adjacent seawater pumps in a string, said number of pumps in the string preferably in the range of three to ten. The hose junction at one end of the string is necessarily an “L” shaped junction, as there is only one adjacent pump with vertical hose, and only one horizontal hose, connected to the junction. At the other end, the “T” junction allows connection to a seafloor hose extending toward shore (FIG. 3). Both the “L” and the “T” end hose connectors are provided with connecting means 38 for mooring ropes 28 and for optional ballast 30, each of said mooring ropes extending to a pulley on a distant mooring or anchor 50, and thence to a subsea float 46 (FIG. 4). The distance of the end “L” or “T” hose connector to the pulley optimally achieves an angle 52 (when taut) of the mooring rope relative to the seafloor of under 25°. At this angle, the upward forces of the buoys rising and falling on waves 42 are substantially converted into lateral forces on the mooring. With a mooring properly embedded in the seafloor (if mud or sand), or provided with angular legs (if rock), the mooring resists these lateral forces which could move the mooring out of position. Given the low angle of the mooring line, the upward force imposed on the mooring is significantly diminished, compared to the upward force if each pump unit was directly attached to a mooring. The mooring line feeds through the pulley to the subsea float which resides substantially vertical to the mooring, and line stoppers 48 are preferably employed to prevent excess payout of mooring line. The subsea float is sized to provide adequate buoyancy which exerts tension on the mooring line. This tension is conveyed to the “L” or “T” junctions at both ends of the horizontal hose, thereby maintaining the horizontal hose under tension. In this manner, the subsea floats and attached ropes act as a spring-mass system, to maintain tension on the horizontal hoses between adjacent hose junctions and thus adjacent pumps in the string. The mooring system is thus able to buffer the dynamic forces imposed by large waves. In addition, as tide levels change, the subsea floats rise or fall to maintain tension and position of the surface floats on the sea surface. Forces imposed by tidal or ocean currents are similarly compensated.

The mooring itself may be comprised of a pyramid-shaped mass with angled legs on each corner, and with an eye 58 on both the apex and on the center of the base, for attaching the pulley (FIG. 5). This mooring can be used apex-down 60 (the pulley being attached to the base eye) for a soft seafloor 62, in which case the apex will tend to bury into the soft material; or apex-up 54 (the pulley being attached to the apex eye) for rock or hard seafloor 56, in which case the angled legs provide resistance against sliding.

Deployment of the aforementioned series of connected pumps is readily achieved using rafts which can be towed from the port to the deployment location, as disclosed in the '480 Application. The rafts are configured to either submerge, or tip laterally, on command, thus releasing into the sea the buoy and pump connected by the gimbal joint, or other components being transported. Prior to the command, the pump 22 and the stack of variable sea anchors 26 located on the deck 68 of the vessel are connected using the layflat hose 66 (FIG. 6). Once released into the sea, the buoy 18 and pump provide a drag force which causes the stack of variable sea anchors to slide off the deck into the sea. As these are stacked from top-most to bottom-most in an accordion fashion, gravity causes them to separate as they sink. The direct connection to the buoy on the surface enables proper depth, spacing, and vertical orientation as the vertical hose is fully extended. As passing waves elevate and then depress the buoy, the attached piston moves up and down inside the cylinder, forcing pressurized water into the vertical hose to enable it to assume a semi-rigid structure.

Given the difficulty of marine operations under harsh ocean conditions, the wave energy technology also must be amenable to maintenance preferably when the seas are less harsh. A method which allows the majority of the system to be transported to a port and lifted onto land, for refurbishment and replacement of worn parts, will be advantageous over a method which must replace worn parts at sea, often under adverse conditions.

The method described herein includes a retrieval line extending to the surface from the subsea float comprising the mooring system. The line is provided with a floating surface marker 72 that is readily identified by the servicing vessel. The line and floating marker may be released from the subsea float by an acoustic signal, or may permanently extend to the surface.

To undertake maintenance, the end of the pump string comprising the “T” connector, along with its subsea float and mooring/pulley are retrieved by the surface vessel. This is accomplished by pulling in the floating surface marker, its retrieval line, and the attached subsea float, which necessarily pulls the mooring to the surface, followed by the “T” connector and its attached hoses. The seafloor hose is detached and provided with a temporary float to enable identification by a servicing vessel, and reconnection at a later time. The subsea float, mooring line, and mooring are lifted onto the vessel. Then, the vertical hose is pulled in which brings up the deepest variable sea anchor, then next-deepest, and then the others one after the other. The vertical hose is disconnected from the bottom of the pump as the last (uppermost) sea anchor is lifted onto the vessel, and a tow line is provided from the vessel preferably to the top of the buoy. The pump, due to its floatation ring, is buoyant since it no longer has the weight of the sea anchors to hold it underwater, and thus floats adjacent to the buoy as it remains connected via the gimbal joint.

By then pulling in the horizontal hose between the end pump and its neighboring pump, the next “T” connector is accessed and this allows the vertical hose to be pulled in, variable seawater anchors retrieved, and the process described above continues. Upon reaching the end of the string with the “L” connector, the final operation involves pulling in the mooring line, mooring with pulley, and its subsea float, all of which are stored on the vessel.

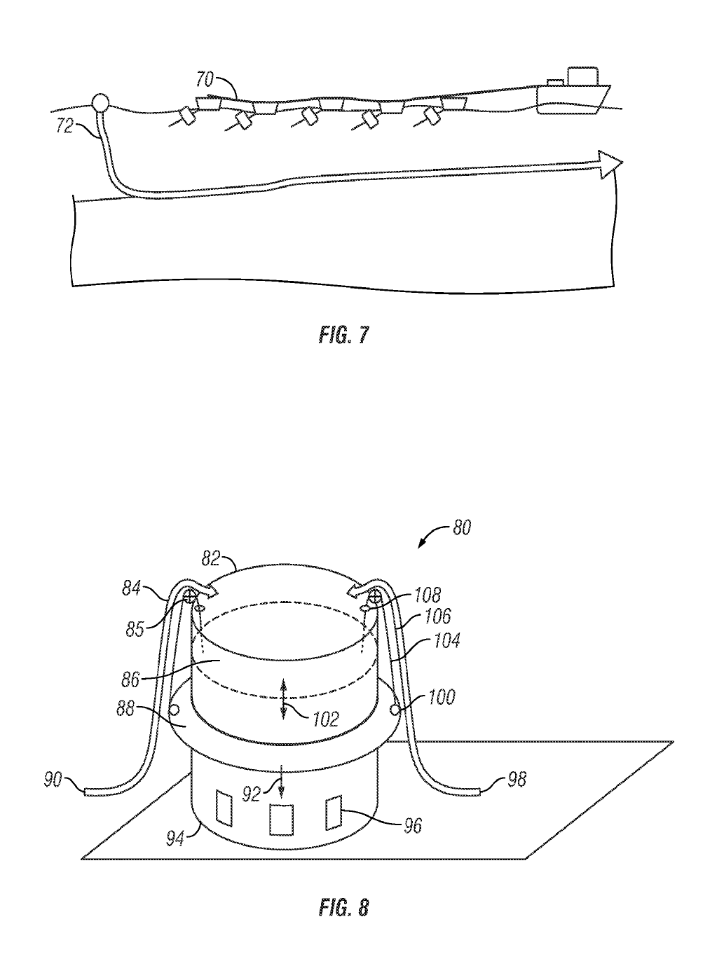

The vessel is then able to tow 70 the interconnected pumps and buoys to the port where they are lifted onshore for necessary servicing (FIG. 7). Similarly, the sea anchors and hoses, as well as moorings including lines and subsea floats, are lifted off the vessel deck onto shore for servicing. A spare string of pumps, including all hoses and complete moorings, may be deployed nearly simultaneously at the same location as the recovered string. This process minimizes downtime since the system is out of service for only a few hours.

The mooring line referred to in this description may be provided with line-stoppers, so that the mooring line does not extend beyond a certain range due to action of the subsea float compensating for large waves or currents. As well, retrieval is expedited as the line stopper encounters the pulley which necessarily retards the entire mooring line from feeding through the pulley.

The current invention 80 also expands upon the '480 Application, which disclosed a storage tank with closed bottom and open top which is positioned on the seafloor 94, by providing one or more heavy moveable components external to the tank, which creates tank pressure greater than the hose pressure, by acting on a moveable baffle inside the tank. In this case, the top of the tank is closed 82, and the moveable baffle 86 is not directly moved by gravity but rather by gravity 92 acting on the external moveable components, as seen in FIG. 8. The rope enters the tank through tightly sealed openings 108, which maintain the inside pressure. A hose 90 comes from the seawater pump of the invention, and a hose 98 also goes to a hydraulic conversion apparatus. Openings 96 are provided in the base of the tank to release pressure beneath the moveable baffle.

For convenience and clarity, FIG. 8 depicts two wire ropes 104 connecting at a connecting point 100 the heavy outer ring 88 to the moveable top, however in practice many such wire ropes would be provided, thereby maintaining a level orientation of the baffle. Pressure differential 102 moves the baffle. Also for clarity, not shown are guides on the inner edge of the heavy outer ring and matching guides on the outer surface of the tank, to maintain orientation and position of the outer ring to prevent uneven movement which could cause binding.

The benefits of this novel configuration are to allow greater versatility in the application of the energy storage system, since the external weights are less restrictive on tank height and diameter.

This is illustrated for the tank invention of the '408 Application by the following calculations: to maintain a suitable pressure of 200 psi inside a tank measuring 20′ diameter and 60′ height, the weight of the heavy top would be about 9 million pounds. Assuming the top is fabricated from a suitable low cost heavy material like pig iron which weighs 450 pounds per cubic foot, each square foot of top would need to weigh about 141,000 pounds, and therefore the moveable top overall dimension must be 20′ diameter by 64 feet height. Obviously, the moveable top of this dimension would restrict the application, because when the tank was full, the moveable top would protrude above the top edge of the tank. Clearly the moveable top cannot move fully above the tank, as the pressure retention purpose is defeated. Even if the pressure relief valves are positioned so the moveable top extends 1/3 above the tank edge, many additional supports would be needed to maintain alignment, and the working volume of the tank would be reduced. In this example, ⅓ of the 64 feet height is about 21 feet above the edge, leaving ⅔ of the moveable top overall height taking the place of stored water. So, 43 feet of the 60 foot tall tank is consumed by the pressure-maintaining moveable top, clearly reducing the efficiency of the storage system.

The present invention overcomes this design shortfall by establishing the weighted component outside, rather than inside, the tank. The tank itself is sealed at the top. The weighted component is attached to the moveable baffle by strong wire ropes which pass over pulleys 85 to move the baffle up or down as the pressure in the tank increases or decreases.

This configuration has the benefit of using the space adjacent to the tank, to reduce the vertical dimension of the weighted component. In the example, by designing the weighted component with an outer diameter of 40′ (e.g., 10′ beyond the outer circumference of the 20′ diameter tank), the horizontal area of this weighted component is 942 square feet. If the same 9 million pounds of weight is required to maintain the 200 psi pressure in the tank, each vertical foot of pig iron weighs about 425,000 pounds and therefore 21 vertical feet of weighted component is required. This provides almost double the storage capacity compared to the aforementioned 64 vertical feet of weighted moveable top, as the useful volume of pressurized seawater inside the 20′ diameter tank becomes 39 vertical feet (12,246 cubic feet) rather than 21 feet (6,594 cubic feet) in the original design.

Further assuming the flow rate into the tank is 450 cubic feet per minute, one can determine the stored capacity for the improved design is 27 minutes of pumped water, compared to 14.7 minutes of capacity in the original design.

This application further discloses a vessel 116 secured to the seafloor which is provided with hydraulic pressure conversion apparatus such as a Pelton motor 112, with the output shaft of the Pelton motor connected to an electrical generator 114. By providing said vessel with onboard hydraulic conversion and electrical generation equipment, the seawater pumps 22 which feed the storage tank can be located in close proximity to the storage tank, or proximate to the vessel if said storage tank is not utilized. With the seawater pumps proximate to the conversion apparatus, the hydraulic pressure transmission distance is much less than if the hydraulic pressure line extended from the seawater pumps to onshore conversion apparatus.

As is well known in the art, transmitting a pressurized fluid over long distances may lead to pressure drop caused by turbulence inside the pressure line. By providing the vessel containing the hydraulic pressure conversion apparatus in close proximity to the seawater pumps, pressure drop is minimized and higher efficiency is achieved. The electricity generated onboard the vessel may be transmitted to land by conventional seafloor electrical cable. Several examples of this seafloor electrical transmission are cited, including the Wave Hub system under construction in the UK (www.wavehub.co.uk), the facilities in use at the European Marine Energy Center (www.emec.org.uk), and the Ocean Sentinal system recently installed by the Oregon State University's Northwest National Marine Renewable Energy Center (http://nnmrec.oregonstate.edu). Neither Wave Hub nor EMEC provide a vessel with hydraulic conversion apparatus, and NNMREC facility provides a surface vessel but without hydraulic conversion apparatus. None of these facilities offer pressurized seawater storage.

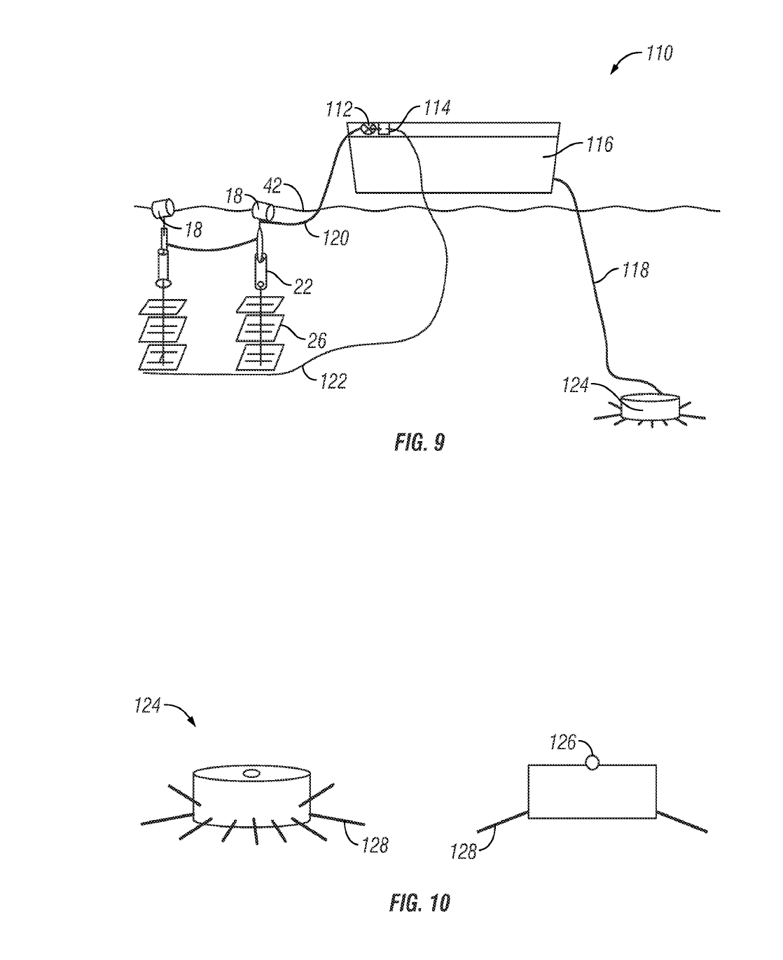

The output of the seawater pumps can be conveyed by hose either directly to the conversion apparatus in the vessel, or into a nearby pressure storage tank and thence to the conversion apparatus in the vessel. The vessel may be a surface vessel or a subsea vessel. This vessel disclosed in the present invention is depicted in FIG. 9.

The present invention further discloses a novel mooring device 124 comprising a weighted object provided with stabilizing appendages and attached to mooring line 118 at connecting ring 126. The appendages 128 protrude at some angle outward from the weighted object to prevent the weight from sliding on the seafloor due to forces imposed on the object such as large waves, ocean currents, or eddies which impose 360 degree movement of water on the mooring device.

Compared to conventional anchors which resist sliding due to forces acting on the anchor only from the direction of the embedded flukes, the disclosed mooring device resists sliding regardless of the direction of forces.

Conventional weighted mooring devices rely solely on the mass of the device to resist sliding. To achieve a stable mooring, these devices must be excessively heavy, which creates difficulties in transport as well as deployment. The particulars of the novel mooring device are illustrated in FIG. 10.

Note further that operational efficiency of a wave-driven hydraulic pump is strongly correlated to the opposing motion of the primary pump components, namely the piston and the cylinder. Many wave-driven hydraulic pumps attach one component (e.g., a cylinder) to the seafloor, and the second component (e.g., piston) to a surface float, to maximize the motion imparted on the second component as the float rises and falls with passing waves. Examples include the pre-commercial designs of Seatricity Ltd, Dartmouth SeaRaser Ltd., Carnegie CETO, INRI Seadog, and others. With one component attached to the seafloor, however, changing tide levels will require a mechanism to compensate since the vertical distance the piston travels (termed “stroke”) is constantly changing with the tides. In the case of Seatricity, this is accomplished with an overly long pump providing extra “stroke” to maintain operation regardless of high and low tides. SeaRaser discloses a telescoping arm to compensate for different tide levels. We believe these approaches are overly costly and/or prone to failure.

Other approaches, including in the '480 Application, and Royset's disclosure in U.S. Patent Publication No. 2008/0206077, involve the use of one or more water anchors with moveable, rigid panels, said water anchors not directly attached to the seafloor, to provide the opposing force. This approach has the advantage of being relatively unaffected by tide levels. Nonetheless, this approach is imperfect because several of these water anchors are needed to prevent the pump cylinder from partly rising on wave upslope. Any rising action of the cylinder reduces the relative motion of the piston, therefore reduces the effective pump stroke, which directly reduces the volume of water produced by the pump. (In this discussion, obviously the piston and cylinder relationship could be opposite—piston attached to water anchor, and cylinder to buoy).

Since the opposing force provided by each water anchor is primarily a function of the horizontal area provided by the anchor when the moveable panels are “closed”, rising action of the cylinder can be prevented by increasing the force—either by increasing the area of the water anchor when panels are closed, or using many water anchors connected in series, or a combination thereof. The problem encountered is the extra weight inherent to the larger/more water anchors, as this weight requires a larger surface buoy. Also, the extra weight increases materials cost, may require a larger vessel for deployment, and the larger water anchor, buoy, and other components may not be easily shipped from the production site to the deployment site. Also, providing several serially connected water anchors will require greater ocean depth to give adequate clearance above the seafloor, which pushes the system farther offshore and increases the transmission distance, and cost. If the serially connected water anchors are closely spaced to function in shallower water nearer to shore, on the wave upslope when the moveable panels are closed, water parcels adjacent each rigid-panel water anchor will be relocated upward into next higher water anchor, which reduces the net “hold-down” force applied on the cylinder.

For these reasons, a new variable water anchor is needed which is strong, lightweight, can be shipped efficiently from the production site to deployment site, is easy to deploy using readily-available vessels, and can be configured with many such devices more closely spaced, to allow deployment closer to shore while avoiding significant upward relocation of water that would reduce the “hold-down” force. With closer spacing, more serially-connected water anchors can be provided, increasing the aggregate area of the panels and improving the “hold-down”. On the rising wave, this improved “hold-down” will be evidenced by near-constant elevation of the pump cylinder with respect to earth, ensuring the piston stroke produces the maximum volume of water on each rising wave.

With this improvement, the wave energy system can be deployed in shallower water, thus be closer to shore, improving the efficiency of transmission and reducing costs.

To achieve these objectives, this invention utilizes flexible panel material rather than rigid panel material to achieve improved results compared to the moveable panels in the '480 Application, and in Royset. In addition, the invention discloses a unique support structure for the flexible panels, to enable efficient stacking, shipping, and deployment of many serially-connected water anchors.

This invention differs from the known prior art in several notable aspects. First and most importantly, water relocation is inherent to each typical water anchor, thereby reducing the “hold-down” force applied to the cylinder, with less pumping efficiency. Second, certain anchors suggest that the fin is semi-rigid, secured transversely by a single hinge rod which would not be operable if flexible, and the fin operates to deflect water laterally.

The panels of the present invention are flexible in both x and y axes, triangular in shape, and secured along the base of the triangle to a first structural member and at the apex by a rope secured to a second structural member.

As the fabric construction is very low mass and very flexible, in operating mode, the panels move from substantially vertical to substantially horizontal on each wave cycle, without substantially relocating the adjacent water. When a sufficient number of panels are in the horizontal position, the “hold down” force applied to the cylinder resists significant upward movement. Since these panels and the cylinder act in unison with adjacent water, this substantially preserves the elevation of the water parcels immediately adjacent the panels, rather than repositioning the adjacent water parcels as disclosed in the '480 Application (“upwelling”), and by Royset.

This novel outcome is obtained by providing several serially-attached stages with sufficient aggregate area of the flexible panels to maintain relative elevation of the cylinder in the water column. This outcome is difficult to achieve using heavier rigid panels such as disclosed in the '480 Application, as more panels increases weight. Conversely, using fewer panels reduces the hold-down force, allowing the cylinder to move upward on rising waves by the rising buoy, while imparting water relocation (upwelling) which further reduces the “hold-down” force imposed on the cylinder. Extra weight also may cause the surface float to partly submerge, moderating its response to passing waves.

The flexible material, which can be a woven or non-woven fabric preferably fabricated in a triangular shape, is fixedly attached along one side of the triangle to a substantially horizontal first structural member, said first structural member being suspended outwardly from a second structural member.

By way of example, the first structural member may be a pipe, rod, box, beam, or similar shape resistant to bending. Multiple said first structural members are either interconnected at angles so as to form a circumference, or formed into an integral circumference. The circumference thus may assume the shape of a triangle, rectangle, hexagon, octagon, circle, or similar shape. During fabrication, any air inside the first structural member can be replaced with a granular substance such as sand or cement, to increase the mass of the first structural member thus increasing tension on the connecting ropes between this member and the second structural member described below.

The second structural member may be a flat plate, substantially smaller in cross-dimension than the circumference of the first structural members, said second member providing several connecting points 1) to the first structural member, 2) to a rope extending off the apex of each triangular flexible panel, and 3) to one or more vertical ropes.

The apex of the flexible panel triangle is provided with a rope which is attached to the inner, second structural member. The rope is of sufficient length to allow the flexible material to rotate about the fixedly attached side, from a substantially horizontal orientation to a substantially vertical orientation. These first and second structural members, and the fixedly attached flexible materials, comprise a single stage of an improved and novel variable water anchor.

The second structural member provides connecting points for one or more ropes extending upward to a pump component, thence to a surface float, and optionally downward to a second stage variable water anchor, said second stage also optionally provided with a rope extending downward to a third stage variable water anchor. Additional stages may be attached so the combined area of flexible panels of all stages, when in horizontal orientation, achieves the desired water anchoring force.

In the preferred embodiment, when deployed in the water, the length of the connecting ropes between the first structural member and the second structural member cause the two members to lie at an angle from horizontal of approximately 30°, although other connecting angles ranging from about 15° to 45° may be used. As disclosed, the apex of each flexible panel is provided with a rope which connects the apex to the second structural member. In an alternative embodiment, multiple ropes may be embedded in or on the flexible panel, for example, one on each free edge and one on the centerline. Upon exiting the apex of the triangular panel, the three ropes may be intertwined or braided to form a single line for securing to the second structural member. The apex of the panel may also be provided with a weight to reduce the response time of the flexible panel as it cycles from vertical to horizontal on each wave.

As described more fully in the '480 Application, the rope extending upwardly from the first stage variable water anchor is attached to a cylinder which houses a piston. The piston is attached to the surface float. As the surface float elevates and then sinks from passing waves, the piston moves up and down inside the cylinder, said cylinder resisting the upward movement of the piston attached to the surface float, due to the “hold-down” effect of the variable water anchors. The cylinder preferably is provided with a buoyancy component, which retards the sinking of the cylinder as the surface float slides off a wave, thus assisting in restoring the piston inside the cylinder. The upward movement of the piston forces seawater held inside the cylinder to exit a pressure valve, into a substantially lateral hose. In this manner, the up and down motion of the surface float generates pressurized seawater.

The lateral hose connects one pump to one or more adjacent pumps in a row, with the pressurized seawater output of the adjacent pumps being additive in the direction of flow. The first and last pumps in the row preferably are connected by a rope or cable to a surface float, which in turn is connected to a seafloor mooring.

In the preferred embodiment, several variable water anchors with flexible panels are connected one to the next beneath the pump cylinder, with optional additional weight affixed to the bottom-most water anchor to maintain tension on the various ropes.

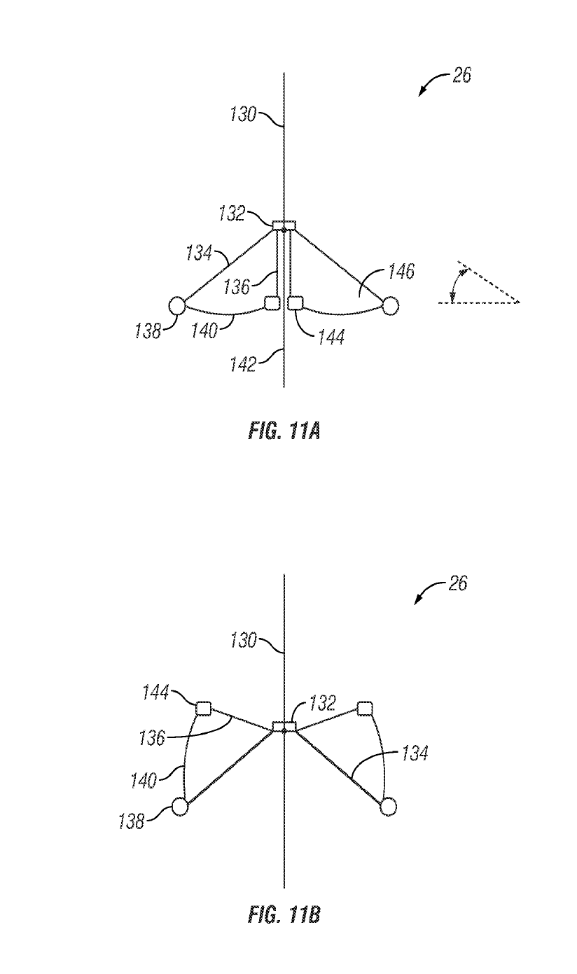

This arrangement of a surface float connected to a pump comprising a piston moveably positioned in a cylinder, said cylinder connected to multiple stages of the water anchors with flexible panels, can be deployed in an efficient manner by arranging the water anchors one above the next on the deck of a vessel, then sequencing the components to slide off the deck of the vessel as it moves. By specifying flexible connectors between the first and second structural members of the variable water anchor, when laid on the deck, the second member resides laterally flush with the first member, thus each stage assumes a small vertical dimension, which allows many stages to be stacked. When deployed, the stages assume their functioning dimension as depicted in FIG. 11A and FIG. 11B, with the flexible anchors 26 having connecting cable 130 to pump, second structural member 132, flexible connector 134 between first structural member and second structural member, connector 136 between apex of panel and second member, first structural member 138, flexible panel 140, connecting cable 142 to next stage water anchor, weight 144 at apex of flexible panel, and preferred angle 146 when buoy rising of about 30 degrees.

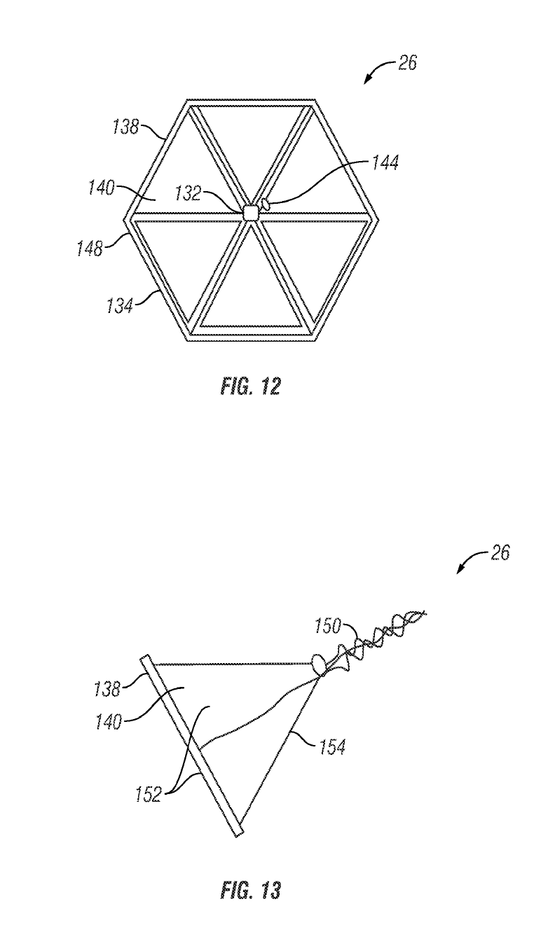

FIG. 12 is a plan view of a hexagonal variable water anchor 26 comprising first structural member 138, second structural member 132, flexible panel 140, flexible panel 148 attached to first structural member, flexible connector 134 between first and second structural members, and weight 144 at apex of each panel.

FIG. 13 provides detail for a flexible panel with braided ropes 150, rope 154 attached to centerlines, and ropes 152 attached to free edges.

Note that in the specification and claims, “about” or “approximately” means within twenty percent (20%) of the numerical amount cited.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A water pressurization system, comprising a substantially vertical assembly, said assembly comprising non-rigid connectors during shipment and storage, with said connectors assuming a semi-rigid form when in operation.

2. The system of claim 1 further comprising a gimbal connection between a surface component and a water pressurizing device, and further comprising a hose connector which connects a substantially vertical hose to a substantially horizontal hose, said hose connector attached to a mooring by a mooring line, such that the distance between the hose connector and the mooring is variable.

3. The system of claim 2 wherein the variable distance between the hose connector and the mooring is governed by a surface or subsea float, said float attached to said mooring line.

4. The system of claim 1 wherein the vertical assembly comprises lay-flat hose.

5. A pressurized seawater storage tank provided with a gravity-induced mechanism external to said tank, to maintain a predetermined pressure in said tank.

6. The tank of claim 5 residing on the seafloor.

7. The tank of claim 6 residing at a depth below the sea surface such that the top edge of said tank avoids interference with vessels on the sea surface.

8. The tank of claim 5 connected by ropes on pulleys to a moveable baffle within the tank.

9. The tank of claim 8 wherein the ropes pass through openings in the tank.

10. The tank of claim 9 wherein the openings are tightly sealed.

11. A moored vessel proximate to a seafloor electrical cable, said vessel provided with means to convert hydraulic pressure to electricity, said electricity conveyed to the seafloor cable by electrical transmission means.

12. The vessel of claim 11 wherein one end of the cable is offshore and the other end is onshore.

13. The vessel of claim 11 in which the vessel is a subsea vessel.

14. A mooring comprising a heavy weight, said weight provided with angled appendages, and further provided with attachment means for a mooring cable.

15. A water anchor comprising flexible panels, said panels causing the water anchor to operate in a cyclical manner.

16. The water anchor of claim 15 wherein the flexible panels comprise woven or non-woven fabric.

17. The water anchor of claim 16 wherein the cycle changes according to wave motion.

18. The water anchor of claim 17 wherein the flexible panels assume a triangular shape, with one edge of the shape connected to a rigid circumferential structure, and the opposing apex of the shape secured by a rope to a second structure vertically offset from the origin of the rigid circumferential structure when the water anchor is operating.

19. The water anchor of claim 15 wherein the water anchor is connected by a rope beneath a water pump.

20. The water anchor of claim 19 wherein multiple water anchors are connected in series beneath a water pump.

21. The water anchor of claim 19 wherein multiple water pumps are connected in series.

22. The water anchor of claim 21 wherein the water pumps are connected by water transmission lines.

23. The water anchor of claim 21 wherein seafloor anchors are provided adjacent to one or both ends of the series of water pumps.

24. A deployment method for an array of water pumps whereby the deployment vessel maintains headway during deployment of at least two individual pumps comprising the array.
